(19) United States
(12) Patent Application Publication
(10) Pub. No.: US 2007/0249764 A1
(43) Pub. Date: Oct. 25, 2007

(54) Aqueous coatings with optical brighteners

(76) Inventors: Glenn Lewis Shoaf, Kingsport, TN (US); Gerald Wayne Ollis, Kingsport, TN (US); Rebecca Reid Stockl, Kingsport, TN (US); Ramesh Chand Munjal, Kingsport, TN (US)

Correspondence Address: Tammye L. Taylor;Eastman Chemical Company, P.O. Box 511, Kingsport, TN, 37662-5075, US

(21) Appl. No.: 11/642,139

(22) Filed: Dec. 20, 2006

Related U.S. Application Data
(60) Provisional application No. 60/793,805, filed on Apr. 21, 2006.

(51) Int. Cl. C08K 5/00

(52) U.S. Cl. 524/87; 524/556; 524/104; 524/107; 524/99

(57) ABSTRACT

Waterborne latexes are commonly used in a variety of coatings including architectural, industrial, paper, and many others. Many coatings would benefit from an incorporated optical whitening or brightening agent. Most common optical brighteners can not be incorporated directly into a water-based system due to their insufficient solubility in water. This report describes a technique for incorporating optical brighteners directly into a water-based latex system using a mini-emulsion polymerization process. Coatings made from these latexes exhibit significant optical whitening/brightening characteristics which greatly enhance the appearance of the coated substrate.

This application claims benefit of provisional application entitled, AQUEOUS COATINGS WITH OPTICAL BRIGHTENER, Ser. No. 60/793,805, filed Apr. 21, 2006, incorporated by reference herein.

### BACKGROUND OF THE INVENTION

This invention pertains to the incorporation of water-insoluble optical brighteners into water-based inks and coatings systems. More particularly, this invention provides a process for incorporating optical brighteners into acrylic or styrene-acrylic or polyvinyl acetate based latexes. These optical brightener-modified latexes can be formulated into coatings systems for use in architectural, industrial, paper, and inks.

### BRIEF SUMMARY OF THE INVENTION

Waterborne latexes are commonly used in a variety of coatings including architectural, industrial, paper, textiles, and many others. Many coatings would benefit from having a fluorescent whitening agent or an optical brightening agent incorporated therein.

Optical brighteners, such as sulfonated stilbenes, are used in water-based coatings, but they are soluble in water and have little or no affinity for the latex polymer, so they reside outside the polymer. As a result, they have very poor fastness properties. Water-insoluble optical brighteners are usually added to polymers such as polyesters in the melt phase prior to extrusion. In these instances, they have better fastness properties, in some part, because they are incorporated into and thereby protected by the polymer. Typically, when optical brighteners are used in a water-based latex coatings they are added with solvents or in dispersions, but the optical brightener resides mostly, if not entirely, outside the polymer.

U.S. Pat. No. 6,521,701 describes the use of specific polymer compositions based on polyvinyl acetate and another water-soluble polymer which promotes water-retention so as to better activate separately added optical brighteners (eg. stilbenes substituted with diamines and disulfonic groups).

U.S. Pat. No. 6,150,494 describes an optical brightener agent possessing at least one polyester reactive group which can be copolymerized with the dicarboxylic acid component, diol and/or diamine component, and a sulfonate-containing monomer. This component is copolymerized directly into the final polymer.

U.S. Pat. No. 6,030,443 describes an additive system for paper coatings of low viscosity nonionic water-soluble polysaccharide derivatives that are used as carriers for optical brightener fluorescing agents in pigmented paper coatings. The use of polysaccharide derivatives enhances the activity of the optical brightener.

U.S. Pat. No. 4,094,634 describes an optical brightener which is mixed and ground in water with an anionic-active and/or nonionic dispersing agents. The operation is carried out, e.g., in a ball mill or sand mill, with the remaining constituents being added before, during or even after the grinding process, so that a preparation having a particle size smaller than 10 microns., especially smaller than 2 microns, is obtained.

U.S. Pat. No. 6,312,822 describes a thermoplastic polymer composition having an optical brightener and an effective amount of a polar compatibility additive to reduce the exudation of the optical brightener from the thermoplastic polymer.

U.S. Pat. No. 5,482,514 describes a process for enhancing the whiteness, brightness and chromaticity of paper making fibres or mixtures thereof by adding photoactivators. The photoactivators are added to the wood pulp by using dispersing agents such as surfactants. They are not incorporated directly into a polymer system.

U.S. Pat. No. 5,340,854 describes the use of cyclodextrins with an optical brightener to form an inclusion compound which retards the migration behavior of the optical brightener providing more uniform color, and improved adherence of emulsion layers in photographic applications.

U.S. Pat. No. 4,210,488 describes a process for improving the dry strength of paper and for improving the effect of optical brighteners in the preparation or coating of paper. It involved the addition of fillers and/or pigments and anionic brighteners to the paper making process the improvement comprising adding to the paper making pulp a polypiperidine. It was found that the performance of optical brighteners can be considerably increased by including minor quantities of the cationic polymer, polypiperidine chloride, and that when fillers and/or pigments are added to the previous admixture of the cationic polymer the substantive adsorption of the optical brightener is improved or made possible, thus making the brightener highly effective.

U.S. Pat. No. 6,339,117 describes polymers made by emulsion polymerization of acrylonitrile-based monomers with or without a co-monomer in the presence of a graftable substrate and adding an optical brightener before, during, or after the emulsion polymerization.

There remains a need in the art for a method of incorporating water-insoluble optical brighteners into water-based latexes and for compositions that contain polymers and water-insoluble optical brighteners homogeneously combined and delivered in stable water-based systems.

### BRIEF SUMMARY OF THE INVENTION

The present invention pertains to water-based latexes resulting from the polymerization product of sheared mini-emulsions with at least one optical brightener and at least one ethylenically unsaturated monomer. The present invention also pertains to methods of preparing latex compositions by contacting at least one optical brightener with at least one ethylenically unsaturated monomer to obtain optical brightener/monomer mixtures; dispersing the optical brightener/monomer mixtures in an aqueous medium to form pre-emulsions; shearing to the pre-emulsions to obtain mini-emulsions; and polymerizing the mini-emulsions.

### BRIEF DESCRIPTION OF THE DRAWINGS

FIG. 1. Effect of Optical Brightener Level on Droplet Size and Droplet Size Distribution.

FIG. 2. Effect of Hydrophobe Type on Droplet Formation.

FIG. 3. L*a*b color measurements with a* vs. b*.

### DETAILED DESCRIPTION OF THE INVENTION

Before the present compositions of matter and methods are disclosed and described, it is to be understood that this invention is not limited to specific synthetic methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described events or circumstances may or may not occur. The description includes instances where the events or circumstances occur, and instances where they do not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

As used herein, the term “mini-emulsion polymerization” refers to a process in which one or more water-insoluble optical brighteners is dissolved in one or more monomers having ethylenic unsaturation to obtain a optical brightener/monomer mixture; the optical brightener/monomer mixture is dispersed in an aqueous medium to form a pre-emulsion; the pre-emulsion is subjected to high stress techniques to form small droplets having an average particle size from about 25 to about 500 nm, known herein as a mini-emulsion; and the mini-emulsion is then polymerized via free radical polymerization using standard emulsion polymerization techniques to form a latex.

The present invention describes a technique for incorporating water-insoluble optical brighteners directly into a water-based latex polymer system using a mini-emulsion polymer process. This process allows for the optical brightener to be hybridized directly with the polymer. Typically, in coating compositions optical brighteners have little if any affinity for pigments and synthetic lattice making them relatively ineffective unless employed with some other component of the coating which has an affinity for the optical brightener. By incorporating the optical brightener within a latex particle, the requisite affinity may be established.

In one aspect, the invention pertains to water-based latexes prepared by polymerizing at least one ethylenically unsaturated monomer in the presence of at least one water-insoluble optical brightening agent. In another aspect, the latexes afford stable, emulsions resulting from the polymerization of at least one acrylic, styrene/acrylic, or vinyl-acrylic monomer in the presence of at least one water-insoluble optical brightener.

In the water-based latexes of the invention, the optical brightener-modified resins generally exists as particles dispersed in water. The particles are generally spherical in shape. The particles may be structured or unstructured. Structured particles include, but are not limited to core/shell particles and gradient particles. The core/shell polymer particles may also be prepared in a multilobe form, a peanut shell, an acorn form, or a raspberry form. It is further preferred in such particles that the core portion comprises about 20 to about 80 wt. % of the total weight of the particle and the shell portion comprises about 80 to about 20 wt. % of the total weight of the particle. The average particle size of the optical brightener-modified latex may range from about 25 to about 500 nm, such as, for example, from about 50 to about 300 nm or from about 100 to about 250 mn.

One embodiment of the present invention pertains to a water-based latex comprising the polymerization product of a sheared mini-emulsion comprising at least one optical brightener dissolved in at least one ethylenically unsaturated monomer.

Another embodiment of the present invention pertains to a method of preparing a latex composition which comprises dissolving at least one optical brightener in one or more ethylenically unsaturated monomers to obtain an optical brightener/monomer mixture; dispersing the optical brightener/monomer mixture in an aqueous medium to form a pre-emulsion; applying shear to the pre-emulsion to obtain a mini-emulsion having an average particle size from about 25 nm to about 500 nm; and polymerizing the mini-emulsion via free radical polymerization to obtain a latex composition.

The polymerization according to the present invention may take place as a single stage or multi-stage feed. If a multi-stage feed is used, one or more stages may contain the optical brightener and one or more stages may contain an additional optical brightener component. Optionally, one or more stages may contain neat monomer without an optical brightener component, in which case, shearing of the monomer mixture to form a mini-emulsion would not be required for this stage. Different optical brightener components may be used in different stages.

Any optical brightener that is soluble in one or more of the ethylenically unsaturated monomers used in the polymerization process is suitable for use in the present invention. In some embodiments, the optical brighteners suitably may have low solubility in water as well. According to the present invention, an optical brightener is considered “dissolved” or soluble in one of the ethylenically unsaturated monomers if after addition and then agitation, a clear to slightly turbid solution mixture forms with no apparent phase separation upon standing (i.e. the solution appears homogeneous).

Examples of suitable optical brighteners include, but are not limited to, the following: benzoxazole derivatives, bis-benzoxazoles; bis-benzoxazolyl-stilbenes; bis-benzoxazolyl-thiophenes, thiophenediyl benzoxazoles, 2,5-thiophenediylbis-(5-tert-butyl-1,3-benzoxazoles); benzoxazole-2,2′-(2,5-thiophendiyl)-bis-[5-(1,1-dimethylethyl)]; 2,2′-(1,2-ethenediyldi-4,1-phenylene)bis-benzoxazoles; phenylcoumarins; bis-(styryl)biphenyls; benzotriazole-coumarins; pyrene-triazines; naphtotriazole-coumarins; bis-(styryl)biphenyls; styrl-bis-benzoxazoles; methyl-coumarins; 2,2′-(2,5-thiophenediyl)bis-(5-tert-butylbenzoxazoles) (CAS #: 7128-64-5); 1,2-diarylethanes; 1,2-diarylethanes; 2-arylbenzazoles; 2(H)-1-benzopyran-2-ones; iminocoumarins; carbostyrils; 3(H)-naphtho[2,1-b]pyan-3-ones; 1,4,5,8-naphthalene-tetracarboxylic acid imides; aminophththalimides; 1,8-naphthalenedicarboximides; 2,5-diaryl-1,3,4-oxadiazoles; quinolines; 2,5-diarylthiophenes; 2,5-diarylfurans; 2,5-diaryl-1,2,4-thiadiazoles; 3(H)-naphtho[2,1-b]pyran-3-imines; 1,3-diphenyl-2-pyrazolines; 2-arylbenzofurans; 2,6-diphenylbenzofurans; 2,2′-bis-(5-phenyl-1,3,4-oxadiazoles); quinoxalines; distyrylarenes; polyarenes; 7(H)-benz[d,e]anthracen-7-ones; 4-methyl-7-diethylaminocoumarins (CAS#: 91-44-1); 3-phenyl-7-(4-methyl-6-butyloxybenzoxazole)coumarins (CAS#: 53850-91-2); 4,4′-bis(benzoxazol-2-yl)stilbenes (CAS#: 1533-45-5); 4-methyl-7-diethylaminocoumarins (CAS#: 91-44-1); 2,4-dimethoxy-6-(1′-pyrenyl)1,3,5-triazines (CAS#: 3271-22-5); 1,4-bis-(benzoxazol-2-yl)naphthalenes (CAS: 5089-22-5); mixtures of 4,4′-bis-(benzoxazol-2-yl)stilbenes and 4-(benzoxazol-2-yl)-4′-(5-methylbenzoxazol-2-yl)stilbenes and 4,4,′-bis-(5-methylbenzoxazol-2-yl)stilbenes (CAS#: 5242-49-9); 3-phenyl-7-(2H-naphtho-[[1,2-d]]triazol-2-yl)coumarins; 4,4′-bis-(2-methoxystyryl)-biphenyls; 2,5-bis-(5-tert-butyl benzoxazol-2-yl)thiophenes; 1,1′biphenyl-4,4′-bis-(2-(methoxyphenyl)ethenyls) ;or oxazole derivatives. Additional examples of suitable optical brightener chromophore types are described in the following references which are incorporated herein by reference: U.S. Pat. No. 4,992,204 and Plastic Additives Handbook, 5^{th} edition, Dr. Hans Zweifel (ed.), Hanser Gardner Publications, Inc., pp. 883-900 (2001).

Further examples of suitable optical brighteners include, but are not limited to, the following: C.I. Fluorescent Brightener 4; C.I. Fluorescent Brightener 39; C.I. Fluorescent Brightener 51; C.I. Fluorescent Brightener 55; C.I. Fluorescent Brightener 57; C.I. Fluorescent Brightener 69; C.I. Fluorescent Brightener 70; C.I. Fluorescent Brightener 72; C.I. Fluorescent Brightener 73; C.I. Fluorescent Brightener 74; C.I. Fluorescent Brightener 75; C.I. Fluorescent Brightener 76; C.I. Fluorescent Brightener 77; C.I. Fluorescent Brightener 78; C.I. Fluorescent Brightener 121; C.I. Fluorescent Brightener 130; C.I. Fluorescent Brightener 135; C.I. Fluorescent Brightener 152; C.I. Fluorescent Brightener 155; C.I. Fluorescent Brightener 156; C.I. Fluorescent Brightener 157; C.I. Fluorescent Brightener 162; C.I. Fluorescent Brightener 164; C.I. Fluorescent Brightener 170; C.I. Fluorescent Brightener 171; C.I. Fluorescent Brightener 179; C.I. Fluorescent Brightener 182; C.I. Fluorescent Brightener 184; C.I. Fluorescent Brightener 185; C.I. Fluorescent Brightener 196; C.I. Fluorescent Brightener 198; C.I. Fluorescent Brightener 199; C.I. Fluorescent Brightener 203; C.I. Fluorescent Brightener 206; C.I. Fluorescent Brightener 227; C.I. Fluorescent Brightener 228; C.I. Fluorescent Brightener 229; C.I. Fluorescent Brightener 236; C.I. Fluorescent Brightener 254; C.I. Fluorescent Brightener 258; C.I. Fluorescent Brightener 269; C.I. Fluorescent Brightener 270; C.I. Fluorescent Brightener 272; C.I. Fluorescent Brightener 273; C.I. Fluorescent Brightener 274; C.I. Fluorescent Brightener 277; C.I. Fluorescent Brightener 281; C.I. Fluorescent Brightener 282; C.I. Fluorescent Brightener 283; C.I. Fluorescent Brightener 285; C.I. Fluorescent Brightener 286; C.I. Fluorescent Brightener 287; C.I. Fluorescent Brightener 288; C.I. Fluorescent Brightener 291; C.I. Fluorescent Brightener 296; C.I. Fluorescent Brightener 297; C.I. Fluorescent Brightener 299; C.I. Fluorescent Brightener 310; C.I. Fluorescent Brightener 315; C.I. Fluorescent Brightener 316; C.I. Fluorescent Brightener 317; C.I. Fluorescent Brightener 323; C.I. Fluorescent Brightener 330; C.I. Fluorescent Brightener 331; C.I. Fluorescent Brightener 341; C.I. Fluorescent Brightener 354; C.I. Fluorescent Brightener 358; C.I. Fluorescent Brightener 359; or C.I. Fluorescent Brightener 393. Additional examples of suitable optical brighteners are described in the following reference which is incorporated herein by reference, Colour Index, 4^{th} edition (online), published by the Society of Dyers and Colourists in association with the American Association of Textile Chemists and Colorists (2002).

The ethylenically unsaturated monomer can be added as a single type of monomer or as a monomer mixture. The ethylenically unsaturated monomer is at least one acrylic or vinyl monomer known in the art capable of substantially solubilizing the optical brightener. Examples of suitable ethylenically unsaturated monomers, include, but are not limited to, styrenic monomers such as, for example, styrene, a-methyl styrene, vinyl naphthalene, vinyl toluene, chloromethyl styrene and the like; ethylenically unsaturated compounds such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethythexyl methacrylate, octyl acrylate, octyl methacrylate, lauryl methacrylate, lauryl acrylate, glycidyl methacrylate, alkyl crotonates, vinyl acetate, di-n-butyl maleate, di-octylmaleate, acetoacetoxyethyl methacrylate, acetoacetoxyethyl acrylate, acetoacetoxypropyl methacrylate, acetoacetopropryl acrylate, diacetone acrylamide, acrylamide, methacrylamide, hydroxyethyl methacrylate, hydroxyethyl acrylate, acrylonitrile, and the like; and nitrogen-containing monomers, such as, for example, t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxyethyl)ethylene urea, and N-(2-methacrylamidoethyl)ethylene urea.

In one embodiment, an additional co-monomer optionally may be included in the polymerization. Suitably, this co-monomer may be any pendant moiety which is capable of (i) surviving the polymerization process and (ii) participating in or promoting crosslinking of the resin. Further, this co-monomer should be capable of participating in or promoting oxidative crosslinking. For example, a latent oxidatively-functional (LOF) acrylic monomer may be used if it provides a source of free radicals to generate a free-radical flux. The LOF group of the co-monomer also may have an ethylenic unsaturation such as, but not limited to, allyl and vinyl groups. The LOF group of the co-monomer also may be an acetoacetoxy moiety or enamine moiety. Preparation of enamines from acetoacetyl groups are described in U.S. Pat. Nos. 5,296,530, 5,494,975, and 5,525,662 which are incorporated herein by reference. Suitable acrylic co-monomers having latent oxidatively-functional (LOF) groups include, but are not limited to, allyl methacrylate, vinyl methacrylate, acetoacetoxyethyl methacrylate, hydroxybutenyl methacrylate, the allyl or diallyl ester of maleic acid, poly(allyl glycidyl ether), or mixtures thereof.

Optionally, in one embodiment of the present invention, a surfactant may be added to the aqueous phase, as a stabilizer, during the polymerization of the mini-emulsion. Typically, the surfactant provides droplet/particle stability, but results in minimal aqueous phase nucleation (micellar or homogeneous). The surfactant can be any conventional surfactant or a combination of surfactants known in the art. Examples of suitable surfactants include, but are not limited to, alkali alkylsulfate, ammonium alkysulfate, alkylsulfonic acid, fatty acid, oxyethylated alkyphenol, sodium dodecyl sulfate, sulfosuccinates and derivatives, or any combination of anionic or non-ionic surfactants. Suitably, polymerizable surfactants may also be used. A further list of suitable surfactants is available in the treatise: McCutcheon's Emulsifiers & Detergents, North American Edition, MC Publishing Co., Glen Rock, N.J., 1997.

In another embodiment of the present invention, an additional polymer or hydrophobic component optionally may be added in the polymerization process. Any polymer or hydrophobic component that is soluble in one or more of the ethylenically unsaturated monomer(s) or mixture of monomers used in the polymerization would be suitable. Suitably, the polymer or hydrophobic material should have a weight average molecular weight of 3000 or greater to provide efficient droplet stabilization. For example, polymers or mixtures of polymers such as, but not limited to, polymethyl methacrylates, polystyrenes, polyvinyl acetates, or alkyds suitably may be used. This polymer or hydrophobic component may be added in an amount of about 0.5 to about 60 wt % based on the weight of the monomer. Typically, about 0.5 to about 5.0 wt % of this polymer or hydrophobic component is required to provide droplet stabilization. However, the amount of hydrophobic component added can be determined based on the properties desired in the final product.

The optical brightener, ethylenically unsaturated monomer, water, as well as the optional surfactant or optional hydrophobic component can be combined in any order to make the pre-emulsion. However, all of these components should be present prior to shearing.

For example, in one embodiment of this invention, the optical brightener is dissolved in at least one ethylenically unsaturated monomer to form an optical brightener/monomer mixture, which is then dispersed in an aqueous medium comprising a surfactant and water to form the pre-emulsion mixture. By further example, in another embodiment, the optical brightener is dissolved in at least one ethylenically unsaturated monomer and a hydrophobic component is pre-dissolved in the monomer or added to the monomer/optical brightener mixture to form an optical brightener/hydrophobe/monomer mixture, which is then dispersed in an aqueous medium comprising a surfactant and water to form the pre-emulsion mixture. In either case, the pre-emulsion mixture then is sheared to form the mini-emulsion.

The shearing of the pre-emulsion mixture to produce a mini-emulsion can be conducted by any means known in the art. For example, any high shear device such as a sonicator, microfluidizer, high speed rotor/stator would be suitable to form the mini-emulsion. Generally, shearing can be achieved using any high shearing device capable of forming droplets ranging in size from about 25 to about 500 nanometers to form the mini-emulsion. Although not wanting to be bound by any theory, it is believed that shearing the mixture to form small droplets, and thus forming the mini-emulsion, prior to polymerization, helps to ensure that the predominant nucleation site and subsequent polymerization site occurs within the droplets. This minimizes transport of the monomer from the droplets which can result in precipitation of the optical brightener.

One example of a method for providing high shear to form the particles is to use a MICROFLUIDIZER® emulsifier, available from Microfluidics Corporation in Newton, Mass. The device consists of a high pressure (up to about 25,000 psi) pump and an interaction chamber where the emulsification takes place. Generally, the reaction mixture is passed through the emulsifier at least once, at a pressure between about 5,000 and about 15,000 psi. Multiple passes may be used to achieve a smaller average particle size or a narrower range of particle size distribution.

Another example of a way to obtain high shear to form a mini-emulsion is by the use of ultrasonic energy or sonication, for example with a Fisher 300 Watt Sonic dismembrator for about 5 minutes at about a 60 percent output (180 watts), with bulk mixing provided by a stirring bar. (The Fisher 300 Watt Sonic dismembrator is manufactured and distributed by Fisher Scientific Company, Pittsburgh, Pa.) Other high shear mixing equipment, e.g., a colloid mill or homogenizer, also can be used. Generally, any equipment capable of producing localized high shear along with moderate bulk mixing can be used.

Alternative modes of applying shear to the pre-emulsification mixture can be used, so long as sufficient shear is applied to achieve the requisite particle size distribution. For purposes of the present invention, the average droplet or particle size is typically from about 25 to about 800 nm, such as, for example, from about 50 nm to about 400 nm, or from about 100 to about 300 nm. After polymerization, typically, less than about 20% of the polymer droplets or particles have a mean diameter greater than about 300 nm.

The mini-emulsion polymerization process by which the aqueous compositions are made may also require a reducing agent, a catalyst or an initiator. Suitable reducing agents are those that increase the rate of polymerization and include, for example, sodium bisulfite, sodium hydrosulfite, sodium formaldehyde sulfoxylate, ascorbic acid, isoascorbic acid, and mixtures thereof.

Suitable catalysts are those compounds that promote decomposition of the polymerization initiator under the polymerization reaction conditions thereby increasing the rate of polymerization. Suitable catalysts include transition metal compounds and driers. Examples of such catalysts include, but are not limited to, ferrous sulfate heptahydrate, chelated forms of ferrous sulfate heptahydrate, ferrous chloride, cupric sulfate, cupric chloride, cobalt acetate, cobaltous sulfate, and mixtures thereof.

Suitable initiators include conventional initiators, such as, for example, ammonium persulfate, ammonium carbonate, ammonium or alkali sulfate, alkali persulfate, hydrogen peroxide, t-butyl hydroperoxide, di-benzoyl peroxide, lauryl peroxide, di-tertiarybutylperoxide, 2,2-azobisisobutyronitrile, benzoyl peroxide, and the like.

In general, the optical brightener portion of the modified latex represents about 0.001-10 wt. %, preferably about 0.01-1 wt. % of the total solids of the latex while the polymer portion of the modified latex represents about 90-99.999 wt. %, preferably about 99.0-99.99 wt. % of the solids contributed by the optical brightener component, any optionally added hydrophobic polymer component, and the acrylic monomers.

The optical brightener modified latexes of this invention can be utilized to produce coating compositions. Coatings made from these latexes exhibit significant optical whitening/brightening characteristics that enhance the appearance of the coating on a given substrate. The optical brightener portion of the modified latex retains the desirable properties of the optical brightener/whitening agent while the polymer portion of the latex provides the general coating properties. Optionally, the optical brightener-modified latexes may be blended with other non-optical brightener containing latexes to provide a fluorescent whitening effect in the latex blend. In some instances, the blended latexes will provide equivalent fluorescent whitening as a single optical brightener-modified latex at a reduced level of total optical brightener.

For example, coatings made using the optical brightener-modified latexes according to the present invention may enhance the optical brightness of an article or coating composition by offseting any discoloration in the article or coating. The degree of fluorescent whitening may be dependent on the type and level of the optical brightener component(s), type and level of monomers, the method of addition, the solids level of the latex, and the formulation of the final coating product.

In addition to appearance, the presence of the optical brightener makes it possible to detect the coating or to check the coating for imperfections such as pinholes, thin spots, etc. by using an ultra-violet light source. Additionally, the optical brightener latex polymer can be used as a tag or marker for security inks and coatings, security documents, bank checks and other printed or coated materials where subsequent detection or identification is desired.

The coating composition may be prepared by an conventional techniques known in the art, e.g. as disclosed in U.S. Pat. Nos. 3,345,313, 4,698,391, 4,737,551, and 6,339,117 each of which is incorporated herein by reference in their entirety. Examples of such coating compositions include, for example, architectural coatings, maintenance coatings, industrial coatings, automotive coatings, textile coatings, inks, adhesives, and coatings for paper, wood, and plastics. Coating compositions of the invention may contain significantly less solvent than either all acrylic or separate optical brightener dispersions, less than 25 wt. % to as low as 1 wt. % and even zero VOC content.

The coating composition may be coated onto a substrate and cured using techniques known in the art (e.g. by spray-applying 3 to 4 mils of wet coating onto a metal panel, and heating in a 150° C. forced air oven for 30 minutes). The substrate can be any common substrate such as paper, polyester films such as polyethylene and polypropylene, metals such as aluminum and steel, glass, urethane elastomers and primed (painted) substrates, and the like. The coating composition of the invention may be cured at room temperature (ambient cure) when appropriate monomers are used (i.e. LOF monomers), at elevated temperatures (thermal cure), or photochemically cured.

A coating composition of the invention may further contain conventional coating additives. Examples of such coating additives include, but are not limited to, one or more of leveling, rheology, or flow control agents such as silicones, fluorocarbons or cellulosics; extenders; reactive coalescing aids such as those described in U.S. Pat. No. 5,349,026, incorporated herein by reference; plasticizers; flatting agents; pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. Further examples of such additives and emulsion polymerization methodology may be found in U.S. Pat. No. 5,371,148, incorporated herein by reference.

Examples of flatting agents include, but are not limited to, synthetic silica, available from the Davison Chemical Division of W. R. Grace & Company under the SYLOID.™. tradename; polypropylene, available from Hercules Inc. under the HERCOFLAT.™. tradename; and synthetic silicate, available from J.M. Huber Corporation under the ZEOLEX.™. tradename.

Examples of dispersing agents and surfactants include, but are not limited to, sodium bis(tridecyl) sulfosuccinnate, di(2-ethylhexyl) sodium sulfosuccinnate, sodium dihexylsulfosuccinnate, sodium dicyclohexyl sulfosuccinnate, diamyl sodium sulfosuccinnate, sodium diisobutyl sulfosuccinnate, disodium iso-decyl sulfosuccinnate, disodium ethoxylated alcohol half ester of sulfosuccinnic acid, disodium alkyl amido polyethoxy sulfosuccinnate, tetra-sodium N-(1,2-dicarboxyethyl)-N-octadecyl sulfosuccinnamate, disodium N-octasulfosuccinnamate, sulfated ethoxylated nonylphenol, 2-amino-2-methyl-1-propanol, and the like.

Examples of viscosity, suspension, and flow control agents include, but are not limited to, polyaminoamide phosphate, high molecular weight carboxylic acid salts of polyamine amides, and alkylene amine salts of an unsaturated fatty acid, all available from BYK Chemie U.S.A. under the ANTI TERRA tradename. Further examples include polysiloxane copolymers, polyacrylate solution, cellulose esters, hydroxyethyl cellulose, hydrophobically-modified hydroxyethyl cellulose, hydroxypropyl cellulose, polyamide wax, polyolefin wax, carboxymethyl cellulose, ammonium polyacrylate, sodium polyacrylate, hydroxypropyl methyl cellulose, ethyl hydroxyethyl cellulose, polyethylene oxide, guar gum and the like. Other examples of thickeners include the methylene/ethylene oxide associative thickeners and water soluble carboxylated thickeners such as, for example, UCAR POLYPHOBE.™. by Union Carbide and ACRYSOL RM 825 available from Rohm and Haas of Philadelphia, Pa.

Several proprietary antifoaming agents are commercially available and include, for example, BUBREAK.™. of Buckman Laboratories Inc., BYK.™. of BYK Chemie, U.S.A., FOAMASTER.™. and NOPCO.™. of Henkel Corp./Coating Chemicals, DREWPLUS.™. of the Drew Industrial Division of Ashland Chemical Company, TRYSOL.™. and TROYKYD.™. of Troy Chemical Corporation, and SAG.™. of Union Carbide Corporation.

Examples of fungicides, mildewcides, and biocides include, but are not limited to, 4,4-dimethyloxazolidine, 3,4,4-trimethyloxazolidine, modified barium metaborate, potassium N-hydroxy-methyl-N-methyldithiocarbamate, 2-(thiocyano-methylthio)benzothiazole, potassium dimethyl dithiocarbamate, adamantane, N-(trichloromethylthio)phthalimide, 2,4,5,6-tetrachloro-isophthalonitrile, orthophenyl phenol, 2,4,5-trichlorophenol, dehydroacetic acid, copper naphthenate, copper octoate, organic arsenic, tributyl tin oxide, zinc naphthenate, and copper 8-quinolinate.

Examples of U.V. absorbers and U.V. light stabilizers include among others substituted benzophenone, substituted benzotriazoles, hindered amines, and hindered benzoates, available from American Cyanamid Company under the CYASORB UV tradename, and diethyl-3-acetyl-4-hydroxy-benzyl-phosphonate, 4-dodecyloxy-2-hydroxy benzophenone, and resorcinol monobenzoate.

Examples of solvents and coalescing agents are well known and include but are not limited to ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, TEXANOL.™. ester alcohol (Eastman Chemical Company), and the like. Such solvents and coalescing aids may also include reactive solvents and coalescing aids such as diallyl phthalate, SANTOLINK XI-100.™. polyglycidyl allyl ether from Monsanto, and others as described in U.S. Pat. Nos. 5,349,026 and 5,371,148, incorporated herein by reference.

Pigments suitable for use in the coating compositions envisioned by the invention are the typical organic and inorganic pigments, well known in the art of surface coatings, for example, those set forth by the Colour Index, 3d Ed., 2d Rev., 1982, published by the Society of Dyers and Colourists in association with the American Association of Textile Chemists and Colorists. Examples include, but are not limited to, the following: titanium dioxide, barytes, clay, or calcium carbonate, CI Pigment White 6 (titanium dioxide); CI Pigment Red 101 (red iron oxide); CI Pigment Yellow 42; CI Pigment Blue 15, 15:1, 15:2, 15:3, 15:4 (copper phthalocyanines); CI Pigment Red 49:1; and CI Pigment Red 57:1. Colorants such as phthalocyanine blue, molybdate orange, carbon black or TIPURE R-746 (a titanium pure slurry available from Dupont Chemical, Inc. of Wilmington, Del.) are also suitable for the coating compositions of the invention.

The examples of various coating compositions of the invention use the following materials not described above: AEROSOL OT-NV surfactant from Cytec Industries, West Patterson, N.J., COBALT HYDROCURE II drier, sold by OMG, Cleveland, Ohio, DOWFAX 2A1 surfactant from Dow Chemical, Midland, Mich., KELSOL 3960-B2G-75, 3922-G-80, 3964-B2G-70, TERGITOL 15-S-40 surfactant sold by Union Carbide Chemical and Plastics Co., Danbury, Conn., and TEXANOL ester-alcohol coalescent sold by Eastman Chemical Company, Kingsport, Tenn.

### EXAMPLES

### Fluorescent Whitening Measurements

Fluorescence Measurement: A Perkin-Elmer LS50B luminescence spectrometer was used to measure optical brightener concentrations in solution using standard samples with known Eastman OB (optical brighteners obtained from Eastman Chemical) levels as controls. Samples were diluted in THF so that the Eastman OB levels were below the saturation limit (160 ppb) for the instrument. The peak emission maxima observed in the samples was the same as that in the calibration standards, suggesting minimal sample matrix effects on emission response.

Brightness Measurement: Brightness was measured using a HunterLab UltraScan XE (or 8000) Sphere Spectrophotometer manufactured by Hunter Associates Laboratory, Inc., Reston, Va. The instrument is operated using HunterLab Universal Software (version 3.8). This instrument conforms to relevant standards such as ASTM E 1164 and E 308. The Spectrophotometer provides five numbers which can be used to help determine brightness. 1. L* is a measure of blackness to whiteness with 0 being completely black and 100 being completely white. 2. a* is a measure of red to green with a positive number increasing in redness and a negative number increasing in green color. 3. b* is a measure of yellow to blue with a positive number increasing in yellowness and a negative number increasing in blueness. Low b* values and High a* values are desired for increased whiteness or brightness.

### Examples 1-10

For each of examples 1-10, 120 g of water was added to a 1000 mL resin kettle equipped with a condenser, nitrogen purge, and a subsurface feed tube. A nitrogen purge was begun and the contents were heated and maintained at 80° C. The Eastobrite OB optical brightener obtained from Eastman Chemical was added to the monomer mix and dissolved. Refer to Table 1 for latex composition data.

In Examples 1 and 6-10, a hydrophobe was also added to the monomer mixture or was pre-dissolved in one of the monomers and then added to the mixture as specified in Table 1. The water and surfactant(s) were premixed, and then the monomer/optical brightener/hydrophobe mix was added to form a pre-emulsion. Surfactants included Aerosol OT-NV (Cytec Industries) and/or Hitenol BC1025 (DKS). 5.0 g of isooctyl mercaptopropionate was added to the pre-emulsion for molecular weight control of the polymer. The pre-emulsion was sheared using an IKA (Model SD-45) rotor/stator homogenizer by pumping through a flow cell which surrounded the shearing device with the homogenizer operating at 100% output to form a mini-emulsion. The pre-emulsion used in Example 3 was not sheared to form a mini-emulsion. 76 g (10%) of the mini-emulsion (or pre-emulsion for Example 3) was charged to the reactor. 0.6 g of ammonium persulfate was mixed in 10 g of water and charged to the reactor. After 15 minutes, the remaining mini-emulsion was fed to the reactor over 180 minutes. Simultaneously, an initiator feed composed of 79.0 g of water, 0.84 g of ammonium persulfate, and 0.84 g of ammonium carbonate was also fed over 180 minutes. After the feeds ended, the reactor was held at 80° C. for 60 minutes, before cooling to 50° C. Then a reductant solution consisting of 6.4 g water, 1.0 g isoascorbic acid, and 1.2 g of 0.5% iron sulfate heptahydrate, and 0.34 g of 28% ammonium hydroxide was added to the reactor. A solution of 19.0 g water and 1.10 g 70% t-butyl hydroperoxide was then fed over 48 minutes. The reaction mix was cooled. The latex was filtered through a 100 mesh wire screen and filterable solids or scrap was collected. The droplet size (mini-emulsion), particle size, viscosity (Brookhaven), and pH of the resulting optical brightener-modified latexes were determined. The droplet and particle sizes were measured using Mictrotrac UPA laser light-scattering device (180° backscattering). The droplets and particles were diluted approximately 1:50 in water. Table 2 summarizes the latex property data for Examples 1-9.

TABLE 1
Compositions of Examples 1–10

| | Monomer Wt. % | Surfactant(s) | Added Hydrophobe | Optical Brightener/ |
|---|---|---|---|---|
| | (BOM + OB + | Wt. % (BOM + | (wt. % BOM + | PPM (BOM + |
| Example | Hydrophobe) | OB + Hydrophobe) | OB + Hydrophobe) | OB + Hydrophobe) |
| 1 | Sty/MMA/EHA/AAEM/ | Aerosol OT-NV/ | Aroplaz 6440-A4- | Eastobrite OB |
| | MAA/AA | Hitenol BC10-25 | 85 | 10000 |
| | 52.0/0.2/22.3/8.0/0.9/1.6 | 1.1/0.4 | 15.0 | |
| 2 | Sty/EHA/MAA/AA | Aerosol OT-NV/ | n/a | Eastobrite OB |
| | 51.7/44.8/0.6/1.8 | Hitenol BC10-25 | | 10000 |
| | | 1.1/0.4 | | |
| 3 - | Sty/EHA/MAA/AA | Aerosol OT-NV/ | n/a | Eastobrite OB |
| no shear | 51.7/44.8/0.6/1.8 | Hitenol BC10-25 | | 10000 |
| | | 1.1/0.4 | | |
| 4 | Sty/EHA/MAA/AA | Aerosol OT-NV/ | n/a | Eastobrite OB |
| | 52.2/45.2/0.6/1.9 | Hitenol BC10-25 | | 1000 |
| | | 1.1/0.4 | | |
| 5 | Sty/EHA/MAA/AA | Aerosol OT-NV/ | n/a | Eastobrite OB |
| | 52.2/45.3/0.6/1.9 | Hitenol BC10-25 | | 100 |
| | | 1.1/0.4 | | |
| 6 | Sty/EHA/MAA/AA | Aerosol OT-NV/ | Polystyrene | Eastobrite OB |
| | 51.8/45.3/0.6/1.8 | Hitenol BC10-25 | 2.0 | 100 |
| | | 1.1/0.4 | | |
| 7 | Sty/EHA/MAA/AA | Aerosol OT-NV/ | Polystyrene | Eastobrite OB |
| | 51.8/45.3/0.6/1.8 | Hitenol BC10-25 | 2.0 | 1000 |
| | | 1.1/0.4 | | |
| 8 | Sty/EHA/MAA/AA | Aerosol OT-NV/ | Polystyrene | Eastobrite OB |
| | 51.8/45.3/0.6/1.8 | Hitenol BC10-25 | 2.0 | 10000 |
| | | 1.1/0.4 | | |
| 9 | Sty/EHA/MAA/AA | Aerosol OT-NV/ | Polystyrene | Eastobrite OB 0 |
| | 51.8/45.3/0.6/1.8 | Hitenol BC10-25 | 2.0 | |
| | | 1.1/0.4 | | |
| 10 | Sty/MMA/BA/ | Aerosol OT-NV/ | Polymethyl | Eastobrite OB |
| | MAA/AA | Hitenol BC10-25 | methacrylate | 100 |
| | 22.6/18.0/54.8/0.6/1.8 | 1.1/0.4 | 2.0 | |

BOM + OB + Hydrophobe = based on monomer + optical brightener + hydrophobic material;
Total solids (theoretical) = 43.6%
Sty = styrene,
EHA = 2-ethylhexyl acrylate,
MMA = methyl methacrylate
AAEM = acetoacetoxy ethyl methacrylate,
MAA = methacrylic acid,
AA = acrylic acid
Aroplaz 6440-A4-85 = Reichhold alkyd (85% solids in n-butyl acetate), medium oil, vegetable oil based, acid value = 9
Eastobrite OB = 2,5-thiophenediylbis-(5-tert-butyl-1,3-benzoxazole)

TABLE 2
Latex Property Summary for Examples 1–9

| | | | | | Viscosity | |
|---|---|---|---|---|---|---|
| | | | | | (cps) #1 | |
| | Droplet | Particle | Solids | | spindle @ | Scrap |
| Example | Size (nm) | Size (nm) | % | pH | 60 RPM | (ppm) |
| 1 | 340 | 140 | 41.1 | 4.2 | 14 | 68 |
| 2 | 390 | 260 | 41.3 | 3.8 | 11 | 395 |
| 3 | n/a | 150 | 42.9 | 4.3 | 22 | 2970 |
| | | | | | | high scrap |
| 4 | 630 | 320 | 41.5 | 3.7 | 10 | 133 |
| 5 | 730 | 200 | 40.8 | 4.2 | 13 | 254 |
| 6 | 420 | 210 | 40.4 | 4.3 | 11 | 212 |
| 7 | 400 | 220 | 41.1 | — | — | 236 |
| 8 | 380 | 210 | 40.8 | — | — | 179 |
| 9 | 410 | 220 | 41.2 | 4.1 | 12 | 144 |

Example 1 demonstrates the ability to incorporate an optical brightener (Eastobrite OB) into a latex using a miniemulsion process with significant amount of a hydrophobic polymer to stabilize the sheared droplets.

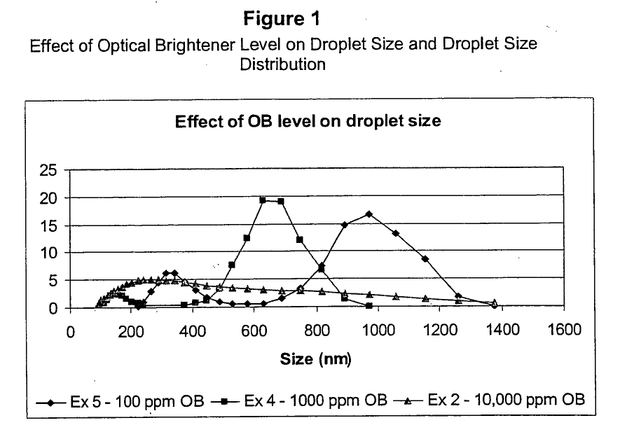

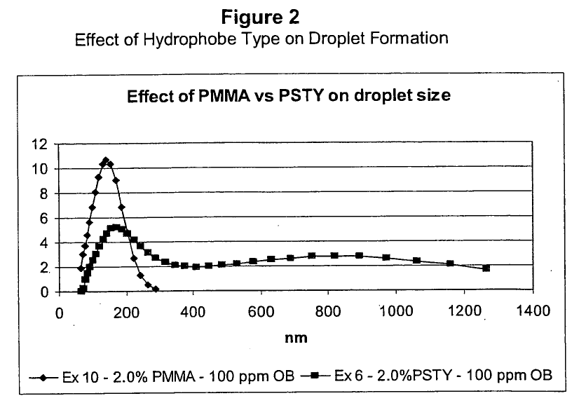

Examples 2, 4, and 5 demonstrate the ability to incorporate an optical brightener (Eastobrite OB) into a latex without an external polymer hydrophobe. The Eastobrite OB serves as the hydrophobe and can provide stabilization of the droplets after shearing. FIG. 1 shows that the droplet size decreases as the level of Eastobrite OB increases indicating a dependence of droplet size on optical brightener level when no added hydrophobe was employed. FIG. 2 shows that the types of hydrophobe used may have an effect on the resultant droplet size and distribution after shearing.

Example 3 demonstrates that without shearing to form a miniemulsion, the latex product generates high levels of scrap. This run was a direct repeat of Example 2, but without the shearing step. Example 2 generated a clean latex with good filtration and low scrap formation. The absence of a large population of small droplets resulted in a shift in the primary particle nucleation from the droplets to the aqueous phase. The monomer in the droplets is subsequently transferred to the separate particles during the polymerization stage leaving the optical brightener without an adequate solvent thus resulting in precipitation, poor filtration, and high scrap as illustrated in Example 3.

### Examples 11-18

Examples 11-18 are samples that were formulated with Texanol as illustrated in Table 3. Table 4 provides the actual versus measured optical brightener levels and the fluorescent measurements for each of these samples. Example 14 is the control latex with no optical brightener added and Examples 15 and 16 are a blend of the control latex with no optical brightener and a latex that contains high levels of optical brightener (10000 ppm on a dry basis). The blend levels were selected to match the total optical brightener found in Examples 12 and 11, respectively. Fluorescence measurements for these samples demonstrates that essentially all of the optical brightener present could be detected whether the optical brightener was fully incorporated via a mini-emulsion or if a latex concentrated in optical brightener was blended with a non-optical brightener containing latex. All optical brightener containing latexes were made via the mini-emulsion polymerization process of this invention. However, Examples 17 and 18 were made by post-adding optical brightener dissolved in Texanol to the non-optical brightener containing latex. Very little fluorescence was detected indicating that the optical brightener was likely precipitated when added to the water-based latex. These results confirm that the optical brightener needs to be incorporated into latex particles to provide the desired level of fluorescence.

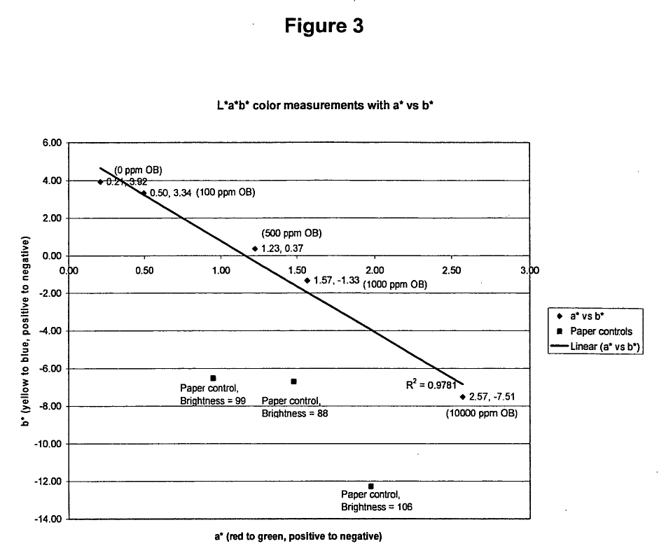

Finally, films were formed from Examples 6-10 and from Example 19 (which is a blend of Example 7 and Example 9) to provide films with the levels of Eastobrite OB shown in Table 5. The L, a, b values were measured and the results are shown in FIG. 3. Several commercial paper controls were also measured and the results are provided for comparison. These results clearly show that the incorporating the optical brightener into a latex which is then applied as a coating on a ‘dead’ (non-brightened) paper, significantly enhances the brightness or whiteness (lowers b* and increases a*) of the paper.

TABLE 3
Formulated Samples Used for Flourescence Measurements

| | | Actual OB | |
|---|---|---|---|
| | Texanol | Concentration in | |
| | Level - | Latex, ppm | |
| Example | phr | (wet basis) | OB's type of incorporation |
| 11 | 10 | 39 | Homogeneous |
| 12 | 10 | 395 | Homogeneous |
| 13 | 10 | 3920 | Homogeneous |
| 14 | 10 | 0 | Control - No OB |
| 15 | 10 | 395 | Blend of control with latex |
| | | | containing 10000 ppm OB (dry |
| | | | basis) |
| 16 | 10 | 40 | Blend of control with latex |
| | | | containing 10000 ppm OB (dry |
| | | | basis) |
| 17 | 10 | 381 | Blend of control with |
| | | | Texanol solution containing |
| | | | 0.5 wt. % OB |
| 18 | 20 | 38 | Blend of control with |
| | | | Texanol solution containing |
| | | | 0.5 wt. % OB |

phr—parts per hundred grams of solid resin

TABLE 4
Measured Optical Brightener (OB) Levels Compared to Actual
Levels with Formulated Samples

| | | Actual OB | Measured OB | |
|---|---|---|---|---|
| | Texanol | Concentration | Concentration | |
| | Level - | in, Latex ppm | in Latex, ppm | |
| Example | phr | (wet basis) | (wet basis) | % Response |
| 11 | 10 | 39 | 34.9 | 89.5 |
| 12 | 10 | 395 | 380.9 | 96.4 |
| 13 | 10 | 3920 | 3641 | 92.9 |
| 14 | 10 | 0 | <4 | N/A |
| 15 | 10 | 395 | 395.3 | 100.1 |
| 16 | 10 | 40 | 42.4 | 106.0 |
| 17 | 10 | 381 | <4 | <1.0 |
| 18 | 20 | 38 | 4.2 | 11.1 |

TABLE 5
L, a, b Values Obtained from Eastobrite OB Containing Films

| | OB Concentration in Latex Film |
|---|---|
| Example | (ppm) |
| 9 | 0 |
| 6 | 100 |
| 19 | 500 |
| 7 | 1000 |
| 8 | 10000 |

wet basis - based on total weight of wet latex

What is claimed is:

1. A water-based latex comprising the polymerization product of a sheared mini-emulsion comprising at least one optical brightener and at least one ethylenically unsaturated monomer.

2. The latex of claim 1, wherein the optical brightener is soluble in one or more of the ethylenically unsaturated monomer(s).

3. The latex of claim 1, wherein the optical brightener is one or more of, benzoxazoles, bis-benzoxazoles, thiophenediyl benzoxazoles, oxazoles, coumarins, stilbene derivatives, bis-benzoxazolyl-stilbenes; bis-benzoxazolyl-thiophenes, carbostyrils, aminophththalimides, quinolines, bis-(styryl)biphenyls, benzotriazole-coumarins; pyrene-triazines; naphtotriazole-coumarins; bis-(styryl)biphenyls; styryl-bis-benzoxazoles; methyl-coumarins, quinoxaline derivatives; distyrylarenes, or polyarenes.

4. The latex of claim 1, wherein the optical brightener is 2,5-thiophenediylbis-(5-tert-butyl-1,3-benzoxazole).

5. The latex of claim 1, wherein the optical brightener is about 0.001 to about 10 wt. % of the total solids of the latex.

6. The latex of claim 1, wherein the optical brightener is about 0.01 to about 1 wt. % of the total solids of the latex.

7. The latex of claim 1, wherein the ethylenically unsaturated monomer is one or more of styrenic monomers such as styrene, α-methyl styrene, vinyl naphthalene, vinyl toluene, chloromethyl styrene and the like; ethylenically unsaturated species such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, alkyl crotonates, vinyl acetate, di-n-butyl maleate, di-octylmaleate, and the like; and nitrogen containing monomers including t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxyethyl)ethylene urea, and N-(2-methacrylamidoethyl)ethylene urea.

8. The latex of claim 1, further comprising one or more of a co-monomer or a hydrophobic polymer.

9. The latex of claim 8, wherein the co-monomer is one or more of allyl methacrylate, vinyl methacrylate, acetoacetoxyethyl methacrylate, hydroxybutenyl methacrylate, the allyl or diallyl ester of maleic acid, or poly(allyl glycidyl ether).

10. The latex of claim 8, wherein the hydrophobic polymer has a weight average molecular weight of 3000 or greater.

11. The latex of claim 8, wherein the hydrophobic polymer is one or more of polymethyl methacrylates, polystyrenes, polyvinyl acetates, or alkyds.

12. The latex of claim 8, wherein the hydrophobic polymer component is from about 0.5 to about 60 wt. % based on the weight of the latex.

13. A method of preparing a latex composition comprising:
a. contacting at least one optical brightener with at least one ethylenically unsaturated monomer to obtain an optical brightener/monomer mixture;
b. dispersing the optical brightener/monomer mixture in an aqueous medium to form a pre-emulsion;
c. shearing to the pre-emulsion to obtain a mini-emulsion; and
d. polymerizing the mini-emulsion.

14. The method of claim 13, wherein the aqueous medium comprises water and a surfactant.

15. The method of claim 14, wherein the surfactant is one or more of alkali or ammonium alkysulfate, alkylsulfonic acid, or fatty acid, oxyethylated alkyphenol, or sulfosuccinates and derivatives.

16. The method of claim 13, wherein the pre-emulsion further comprises at least one ethylenically unsaturated co-monomer.

17. The method of claim 16, wherein the co-monomer is one or more of allyl methacrylate, vinyl methacrylate, acetoacetoxyethyl methacrylate, hydroxybutenyl methacrylate, the allyl or diallyl ester of maleic acid, or poly(allyl glycidyl ether).

18. The method of claim 13, wherein the optical brightener is soluble in at least one of the monomers.

19. The method of claim 13, wherein the mini-emulsion has a droplet size ranging from about 25 nm to about 800 nm.

20. The method of claim 13, wherein the mini-emulsion has a droplet size ranging from about 50 nm to about 500 nm.

21. The method of claim 13, wherein the pre-emulsion further comprises a hydrophobic polymer component.

22. The method of claim 21, wherein the hydrophobic polymer has a weight average molecular weight of 3000 or greater.

23. The method of claim 21, wherein the hydrophobic polymer is one or more of polymethyl methacrylates, polystyrenes, polyvinyl acetates, or alkyds

24. The method of claim 21, wherein the hydrophobic polymer component is added in an amount from about 0.5 to about 60 wt. % based on the weight of the latex.

25. The method of claim 21, wherein the hydrophobic polymer component is added in an amount from about 0.5 to about 5.0 wt. % based on the weight of the latex.

26. The method of claim 13, wherein the particle size of the latex composition is from about 25 nm to about 500 nm.

27. The method of claim 13, wherein the particle size of the latex composition is from about 50 nm to about 300 nm.

28. The method of claim 13, wherein the particle size of the latex composition is from about 100 nm to about 250 nm.

29. The method of claim 13, wherein the optical brightener is one or more of benzoxazoles, bis-benzoxazoles, thiophenediyl benzoxazoles, oxazoles, coumarins, stilbene derivatives, bis-benzoxazolyl-stilbenes; bis-benzoxazolyl-thiophenes, carbostyrils, aminophththalimides, quinolines, bis-(styryl)biphenyls, benzotriazole-coumarins; pyrene-triazines; naphtotriazole-coumarins; bis-(styryl)biphenyls; styryl-bis-benzoxazoles; methyl-coumarins, quinoxaline derivatives; distyrylarenes, or polyarenes.

30. The method of claim 13, wherein the optical brightener is 2,5-thiophenediylbis (5-tert-butyl-1,3-benzoxazole).

31. The method of claim 13, wherein the ethylenically unsaturated monomer is one or more of styrenic monomers such as styrene, α-methyl styrene, vinyl naphthalene, vinyl toluene, chloromethyl styrene and the like; ethylenically unsaturated species such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, glycidyl methacrylate, carbodiimide methacrylate, alkyl crotonates, vinyl acetate, di-n-butyl maleate, di-octylmaleate, and the like; and nitrogen containing monomers including t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxyethyl)ethylene urea, and N-(2-methacrylamidoethyl)ethylene urea.

32. A water-based latex composition produced by the process of claim 13.

33. A coating composition comprising the water-based latex composition of claim 1.

34. A coating composition comprising a water based latex of claim 1 and at least one additive selected from the group consisting of rheology agents, flow control agents, extenders, reactive coalescing aids, plasticizers, flatting agents, pigment wetting and dispersing agents, surfactants, ultraviolet (UV) absorbers, UV light stabilizers, tinting pigments, colorants, defoaming agents, antifoaming agents, anti-settling, anti-sag and bodying agents, anti-skinning agents, anti-flooding agents, anti-floating agents, biocides, fungicides, mildewcides, corrosion inhibitors, thickening agents, and coalescing agents.

35. The coating composition of claim 34, wherein the composition provides significant optical whitening/brightening characteristics in architectural coatings, maintenance coatings, industrial coatings, automotive coatings, textile coatings, inks, adhesives, or coatings for paper, wood, and plastics.
